(19) United States
(12) Patent Application Publication
(10) Pub. No.: US 2026/0221477 A1
(43) Pub. Date: Jul. 30, 2026

(54) FUEL CELL SYSTEM AND METHOD FOR STARTING A FUEL CELL SYSTEM

(71) Applicant: Robert Bosch GmbH, Stuttgart (DE)

(72) Inventors: Simon Buehler, Stuttgart (DE); Christian Krause, Stuttgart (DE); Saskia Bostelmann, Speyer (DE)

(21) Appl. No.: 19/149,682

(22) PCT Filed: Jan. 15, 2024
(86) PCT No.: PCT/EP2024/050815

§ 371 Date: Jul. 21, 2025

(30) Foreign Application Priority Data
Jan. 25, 2023 (DE) 10 2023 200 579.4

(51) Int. Cl. H01M 8/04746; H01M 8/0438

(52) U.S. Cl. CPC H01M 8/04783; H01M 8/04388; H01M 8/04753

(57) ABSTRACT

The present invention relates to a fuel cell system (100) for converting energy. The fuel cell system (100) comprises:
a fuel cell stack (101) which comprises a cathode subsystem (103) and an anode subsystem (105),
an outlet system (107) for discharging anode gas from the anode subsystem (105),
a supply system (109) for supplying the anode subsystem with hydrogen (105),
a pressure sensor (111) which is configured to detect a pressure difference between the cathode subsystem (103) and the anode subsystem (105),
a computing unit (113),
wherein the supply system (109) is configured so as to introduce hydrogen into the anode subsystem (105) in order to set a specified pressure difference with respect to a pressure present in the cathode subsystem (103),
wherein the computing unit (113) is configured so as to ascertain a starting pressure present in the fuel cell stack (101) by means of the pressure sensor (111) during a starting process of the fuel cell system (100), and to actuate the outlet system (107) such that a mass flow discharged from the anode subsystem (105) causes a non-hydrogen-containing gas mixture present in the anode subsystem (105) at the starting pressure to be enriched with hydrogen provided by the supply system (109) up to a specified minimum hydrogen concentration.

### BACKGROUND

The invention relates to a fuel cell system and a method for starting a fuel cell system.

Polymer electrolyte membrane (PEM) fuel cell systems convert hydrogen by means of oxygen into electrical energy, generating waste heat and water.

A PEM fuel cell consists of an anode supplied with hydrogen, a cathode supplied with air, and a polymer electrolyte membrane placed between them, where air and oxygen are converted into electricity, water, and heat. Several such fuel cells are stacked together to form a fuel cell stack in order to maximize the voltage generated.

Systemically, an approach has been established for supplying hydrogen to the PEM anode in which the hydrogen-rich anode exhaust gas is fed back to the anode inlet together with fresh hydrogen by means of gas delivery units. This approach is known as recirculation.

A measure of recirculation is the ratio of hydrogen supplied to the fuel cell stack to the hydrogen consumed by the electrochemical reaction; this ratio is called lambda.

Alongside hydrogen concentration, lambda is an essential parameter for fuel cell stacks. A sufficiently high lambda ensures that the catalytic converter in the fuel cell stack is supplied with sufficient hydrogen across the entire flow range.

Diffusion processes also cause nitrogen to reach the anode side. Nitrogen serves as an inert gas for the electrochemical reaction taking place in the fuel cell. Recirculation causes nitrogen to accumulate in the anode path, reducing the quantity of hydrogen that can be supplied to the anode. This causes the lambda value to drop, which can lead to a reduction in cell voltage. If a fuel cell is no longer supplied with sufficient hydrogen, this can damage the fuel cell.

Particularly after a prolonged period of inactivity, nitrogen accumulates on the anode, meaning that before a fuel cell system can be started, the hydrogen concentration must first be adjusted to a level suitable for start-up by venting the anode gas. This process is slow, delays start-up and thus reduces the availability of the fuel cell system.

In addition, purge air must be supplied from the cathode subsystem to dilute any hydrogen present in the anode subsystem. This process leads to further energy losses.

In known fuel cell systems, hydrogen is discharged for a fixed period of time in order to achieve the hydrogen concentration required for start-up under all circumstances.

### SUMMARY

Presented in the context of the invention are a fuel cell system and a method for starting a fuel cell system. Further features and details of the invention arise from the respective dependent claims, the description, and the drawings. In this context, features and details described in connection with the method according to the invention clearly also apply in connection with the fuel cell system according to the invention, and vice versa, so that mutual reference to the individual considerations of the invention always is or can be made with respect to the disclosure.

The invention presented is particularly useful for providing a robust and energy-efficient fuel cell system.

Therefore, according to a first aspect of the present invention, a fuel cell system for converting energy is presented. The fuel cell system presented comprises a fuel cell stack comprising a cathode subsystem and an anode subsystem, an outlet system for discharging anode gas from the anode subsystem, a supply system for supplying the anode subsystem with hydrogen, a pressure sensor configured to capture a pressure in the fuel cell stack, and a computing unit.

The supply system is configured to introduce hydrogen into the anode subsystem in order to set a specified pressure difference with respect to a pressure present in the cathode subsystem.

The computing unit is configured so as to ascertain a starting pressure present in the fuel cell stack by means of the pressure sensor during a starting process of the fuel cell system, and to actuate the outlet system such that a mass flow discharged from the anode subsystem causes a non-hydrogen-containing gas mixture present in the anode subsystem at the starting pressure to be enriched with hydrogen provided by the supply system up to a specified minimum hydrogen concentration.

In the context of the invention presented here, a computing unit is understood to mean a computer, a control unit, a processor, or any other programmable circuit.

The invention is based on the assumption that a gas mixture present in the anode subsystem of the fuel cell system at a starting pressure when the system is started does not comprise hydrogen, so that a worst-case scenario arises in which all of the hydrogen required for starting must be fed into the anode subsystem.

The pressure sensor provided according to the invention can be configured to capture a pressure present in the fuel cell stack, in particular in the anode subsystem and/or in the cathode subsystem.

According to the invention, the hydrogen is dosed depending on the starting pressure, i.e., a pressure present in the fuel cell stack, in particular in the anode subsystem, at start-up, so that a portion of a gas mixture present in the anode subsystem of the fuel cell stack at start-up is used to establish an atmosphere required for start-up and the entire anode subsystem is not emptied and completely filled with fresh hydrogen.

Based on the determined starting pressure, the gas mixture present in the anode subsystem is enriched with hydrogen only to the extent that a specified minimum hydrogen concentration or a predetermined minimum hydrogen content of, for example, between 50% and 70% is present in the anode subsystem. Accordingly, the quantity of hydrogen dosed into the anode subsystem for a start is minimized.

It may be provided that the computing unit is configured to determine, on the basis of the starting pressure, a quantity of hydrogen which is required to enrich the non-hydrogen-containing gas mixture present in the anode subsystem at the starting pressure with hydrogen to such an extent that the specified minimum hydrogen concentration is established in the anode subsystem, and to actuate the outlet system such that it allows a mass flow from the anode subsystem which causes the supply system to feed the determined quantity of hydrogen into the anode subsystem.

The computing unit of the fuel cell system described above can determine a duration for which the outlet system must be activated in order to discharge a mass flow from the anode subsystem which causes the supply system, which comprises, for example, a pressure regulator, to set the specified hydrogen concentration in the anode subsystem. based on the starting pressure or determine it using a characteristic map or an allocation scheme. Once the duration is known, the outlet system can be adjusted accordingly so that the supply system automatically follows and adjusts the hydrogen concentration.

It may be provided that the pressure sensor comprises a sensor element arranged upstream of a hydrogen metering valve of the supply system and a sensor element arranged downstream of the hydrogen metering valve.

To calculate the duration for which the outlet system is to be activated, a quantity of hydrogen can be determined which is required to enrich the non-hydrogen-containing gas mixture present at the starting pressure in the anode subsystem with hydrogen until the specified minimum hydrogen concentration is reached in the anode subsystem. The quantity of hydrogen can be determined, for example, using equation (1).

$${C}_{H2} = \frac{Δ p}{{p}_{end}} = \frac{Δ p}{{p}_{begin} + Δ p} \qquad ( 1 )$$

Here, c_{H2} represents a hydrogen concentration, Δp represents a pressure difference between the starting pressure and a predetermined maximum pressure difference, p_{end} represents a target pressure, and p_{begin} represents the starting pressure.

It may also be provided that the computing unit is configured to activate the outlet system when a predetermined maximum pressure in the fuel cell stack is reached.

In the event that the starting pressure is so high that a quantity of hydrogen must be dosed into the anode subsystem to achieve the specified hydrogen concentration, which would require a pressure greater than the specified maximum pressure, gas must be exported from the anode subsystem before the hydrogen is dosed in. An outlet system, such as a purge valve or a drain valve of the fuel cell system, can be activated for this purpose.

It may be provided that the computing unit is configured to determine a mass flow to be carried out through the outlet system based on a pressure applied in the anode subsystem prior to activation of the outlet system and a pressure ratio of ambient pressure and anode pressure using the nozzle flow equation.

The nozzle flow equation (2) can be used to determine the mass flow to be discharged and, as a result, the activation time of the outlet system.

$${\dot{m}}_{out} = A \times μ \times ψ ( \frac{{P}_{atm}}{{P}_{Anode}} , K ) \times \sqrt{2 \times {P}_{Anode} \times {P}_{Anode}} \qquad ( 2 )$$

\dot{m}ₒᵤₜ stands for a mass flow to be executed, A for a flow cross-section, μ for a specified discharge coefficient, ψ for a specified discharge function, pₐₜₘ for ambient pressure, p_{Anode} for pressure at the anode, and K for the adiabatic exponent.

It may further be provided that the computing unit is configured to determine a concentration of hydrogen present in the anode subsystem upon activation of the outlet system by the following equation.

$$\frac{dc}{dt} = \frac{{\dot{m}}_{out}}{{n}_{tot}} \times \frac{1 - c}{c \times {M}_{H 2} + ( 1 - c ) \times {M}_{N 2}} \qquad ( 3 )$$

Here, nₜₒₜ stands for the total number of particles, M_{H2} for the quantity of hydrogen, and M_{N2} for the amount of nitrogen in the anode subsystem.

It may be provided that the computing unit is configured to determine a mass flow to be discharged through the outlet system on the basis of a predetermined allocation scheme, wherein the allocation scheme allocates an activation duration for activating the outlet system to a respective starting pressure relative to a reference pressure, in particular an ambient pressure, which is determined downstream of a hydrogen metering valve of the supply system.

To open the anode system to the outlet system, the duration of the opening can be evaluated from the cross-section of a hydrogen metering valve and a pressure delta across the hydrogen metering valve. For this purpose, the anode pressure can be determined by a pressure sensor in the fuel cell stack. Various pressures can be used to determine the reference pressure after the hydrogen metering valve, such as a pressure determined by a pressure sensor directly after the hydrogen metering valve. Alternatively, a pressure determined by a pressure sensor anywhere in the exhaust gas line between the hydrogen metering valve and the end of the exhaust can be used, wherein any inductors and thus differences to the pressure directly after the hydrogen metering valve must be taken into account. Furthermore, an ambient pressure determined by an ambient pressure sensor can be used. In this case, the ambient pressure can be calculated backwards through the entire exhaust system, since the ambient pressure is the pressure at the maximum distance from the hydrogen metering valve.

Using a specified allocation scheme, such as a characteristic map, an activation duration for activating the outlet system can be determined quickly and easily.

According to a second aspect, the invention relates to a method for starting a fuel cell system, in particular a fuel cell system according to the first aspect of the invention. The method comprises determining a starting pressure present in a fuel cell stack of the fuel cell system during a starting process by means of a pressure sensor and -controlling one of the outlet systems of the fuel cell system such that enough anode gas is discharged from the anode subsystem that a non-hydrogen-containing gas mixture present in the anode subsystem at the starting pressure is enriched with hydrogen up to a specified minimum hydrogen concentration by the supply system.

It may be provided that a duration for which the outlet system is actuated is calculated on the basis of the starting pressure.

By determining the duration for which the supply system is actuated, the specified minimum hydrogen concentration can be set precisely without an adjustment process and correspondingly quickly.

It may also be provided that, when a predetermined maximum pressure is reached in the anode subsystem, a duration for which the outlet system of the fuel cell system is actuated is determined on the basis of a predetermined characteristic map, wherein the characteristic map assigns an activation duration for activating the outlet system to a starting pressure in the anode subsystem and an ambient pressure.

### BRIEF DESCRIPTION OF THE DRAWINGS

Further advantages, features, and details of the invention arise from the following description, in which exemplary embodiments of the invention are described in detail with reference to the drawings. In this context, the features mentioned in the claims and in the description can each be essential to the invention individually or in any combination.

The following is shown:

FIG. 1 shows a schematic representation of one possible embodiment of the presented fuel cell system,

FIG. 2 a possible embodiment of the method presented here,

FIG. 3 an allocation scheme for determining a quantity of hydrogen to be metered in,

FIG. 4 an allocation scheme for determining an activation time of an outlet system of a fuel cell system.

### DETAILED DESCRIPTION

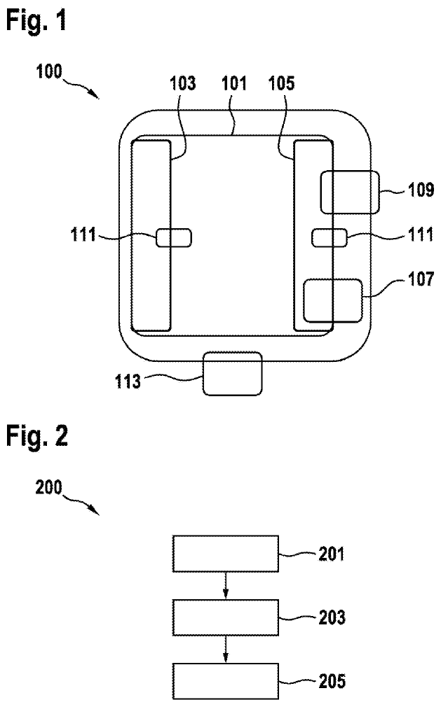

FIG. 1 shows a fuel cell system 100. The fuel cell system 100 comprises a fuel cell stack 101 comprising a cathode subsystem 103 and an anode subsystem 105, an outlet system 107 for discharging anode gas from the anode subsystem 105, a supply system 109 for supplying the anode subsystem 105 with hydrogen, a pressure sensor 111 configured to capture a pressure present in the fuel cell stack 101, and a computing unit 113.

The computing unit 113 is configured so as to ascertain a starting pressure present in the fuel cell stack 101 during a starting process of the fuel cell system 100 by means of the pressure sensor 111, and to actuate the outlet system 107 such that a mass flow diverted from the anode subsystem 105 enriches a non-hydrogen-containing gas mixture present in the anode subsystem 105 with hydrogen supplied by the supply system 109 up to a specified minimum hydrogen concentration. For this purpose, the computing unit 113 can, for example, use the starting pressure so as to ascertain an additional quantity of hydrogen that is required to enrich the non-hydrogen-containing gas mixture present in the anode subsystem 105 at the starting pressure with hydrogen until the specified minimum hydrogen concentration is reached in the anode subsystem 105. The duration for which the outlet system 107 is to be actuated in order to allow the determined amount of additional hydrogen to be supplied by the supply system 109 can be determined on the basis of an allocation scheme or a mathematical relationship.

FIG. 2 shows a method 200 for starting the fuel cell system 100.

In a determination step 201, a starting pressure present in the fuel cell stack 101 of the fuel cell system 100 during a starting process is determined by means of the pressure sensor 111.

In a control step 203, the outlet system 107 of the fuel cell system 100 is actuated such that so much anode gas is discharged from the anode subsystem 105 that a non-hydrogen-containing gas mixture present in the anode subsystem 105 at the starting pressure is enriched with hydrogen up to a specified minimum hydrogen concentration by the supply system 109.

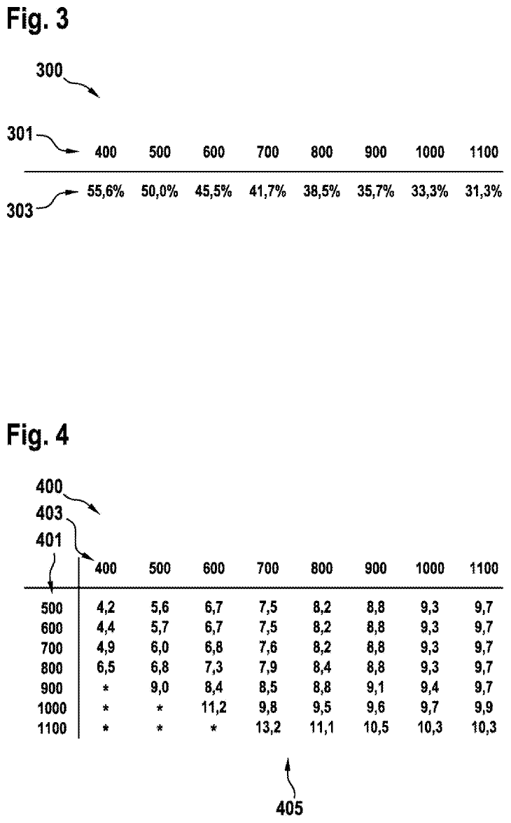

In an optional determination step 205, a duration for which the outlet system 109 is to be actuated, i.e., activated, is determined on the basis of the starting pressure. An allocation scheme 300 according to FIG. 3 can be used for this purpose.

In determination step 205, a duration for which the outlet system 109 of the fuel cell system 100 is to be activated in order not to exceed a predetermined maximum pressure in the fuel cell stack 101 and to adjust the hydrogen concentration accordingly can also be determined. An allocation scheme 400 according to FIG. 4 can be used for this purpose.

The method 200 thus essentially consists of two parts. On the one hand, a controller in the background sets a pressure in the anode subsystem 105, i.e., an offset to the pressure in the cathode subsystem 103. This results in a temporary change in pressure in the anode subsystem 105. This change in pressure in the anode subsystem 105 is equivalent to an increase in the hydrogen concentration in the anode subsystem 105.

On the other hand, anode gas is omitted. For this purpose, a mass flow is determined depending on the ambient pressure and the pressure in the anode subsystem 105, which is discharged from the anode subsystem 105 via the outlet system 109. This indirectly results in an increase in the hydrogen concentration in the anode subsystem 105 again due to the discharge of nitrogen and hydrogen from the anode subsystem 105, since the controller is active in the background to set the pressure in the anode subsystem 105 as an offset to the pressure in the cathode subsystem 103.

In both cases, no hydrogen is consumed by current drawing. Opening the metering valve always delivers 100% hydrogen, thereby increasing the hydrogen concentration in the anode subsystem 105.

FIG. 3 shows an allocation scheme 300. The allocation scheme assigns a starting pressure in mbar specified in line 301 to a hydrogen concentration in % that can be provided in line 303 by dosing hydrogen up to a permissible maximum pressure difference across the fuel cell stack membrane of 500 mbar above the starting pressure. It can be seen that, starting from a starting pressure of 400 mbar, a target concentration of 60% hydrogen cannot be achieved while maintaining the permissible maximum pressure difference. Accordingly, starting from a starting pressure of 400 mbar, a gas mixture must be discharged from the anode subsystem in order to achieve the target concentration of 60% hydrogen.

FIG. 4 shows an allocation scheme 400 which allocates a reference pressure specified in column 401 in the form of an ambient pressure or atmospheric pressure in mbar or a pressure after a hydrogen metering valve, and a starting pressure specified in line 403, assigns an activation duration of an outlet system specified in a matrix 405 in seconds, which is required to discharge enough gas mixture from the anode subsystem and to set the target concentration of, for example, 60% hydrogen content.

1. A fuel cell system (100) for converting energy,
wherein the fuel cell system (100) comprises:
a fuel cell stack (101) which comprises a cathode subsystem (103) and an anode subsystem (105),
an outlet system (107) for discharging anode gas from the anode subsystem (105),
a supply system (109) for supplying the anode subsystem with hydrogen (105),
a pressure sensor (111) configured to detect a pressure present in the fuel cell stack (101), and
a computing unit (113),
wherein the supply system (109) is configured to introduce hydrogen into the anode subsystem (105) in order to set a specified pressure difference with respect to a pressure present in the cathode subsystem (103),
wherein the computing unit (113) is configured so as to ascertain a starting pressure present in the fuel cell stack (101) by means of the pressure sensor (111) during a starting process of the fuel cell system (100), and to actuate the outlet system (107) such that a mass flow discharged from the anode subsystem (105) causes a non-hydrogen-containing gas mixture present in the anode subsystem (105) at the starting pressure to be enriched with hydrogen provided by the supply system (109) up to a specified minimum hydrogen concentration.

2. The fuel cell system (100) according to claim 1,
wherein
the computing unit (113) is configured to determine, based on the starting pressure, a quantity of hydrogen which is required to enrich the non-hydrogen-containing gas mixture present in the anode subsystem (105) at the starting pressure with hydrogen to such an extent that the specified minimum hydrogen concentration is established in the anode subsystem (105), and
to actuate the outlet system (107) such that it discharges a mass flow from the anode subsystem (105) which causes the supply system (109) to feed a specified quantity of hydrogen into the anode subsystem (105).

3. The fuel cell system (100) according to claim 1- or 2,
wherein
the pressure sensor (111) comprises a first sensor element for determining a pressure present upstream of a hydrogen metering valve of the supply system (109) and a second sensor element for determining a pressure present downstream of the hydrogen metering valve.

4. The fuel cell system (100) according to claim 1,
wherein
the computing unit (113) is configured to activate the outlet system when a predetermined maximum pressure in the fuel cell stack (101) is reached.

5. The fuel cell system (100) according to claim 1,
wherein
the computing unit (113) is configured to determine a mass flow to be discharged through the outlet system (107) based on a pressure present in the anode subsystem (105) prior to activation of the outlet system (107) and a pressure ratio of ambient pressure and anode pressure using a nozzle flow equation.

6. The fuel cell system (100) according to claim 1,
wherein
the computing unit (113) is configured to determine a concentration of hydrogen present in the anode subsystem (105) upon activation of the outlet system (107) by the following equation:
$$\frac{dc}{dt} = \frac{{\dot{m}}_{out}}{{n}_{tot}} \times \frac{1 - c}{c \times {M}_{H 2} + ( 1 - c ) \times {M}_{N 2}} .$$

7. The fuel cell system (100) according to claim 1,
wherein
the computing unit (113) is configured to determine a mass flow to be discharged through the outlet system (107) based on a predetermined allocation scheme, wherein the allocation scheme assigns an activation duration for activating the outlet system (107) to a respective starting pressure and a reference pressure, which is determined downstream of a hydrogen metering valve of the supply system (109).

8. A method (200) for starting a fuel cell system (100) according to claim 1,
wherein the method (200) comprises:
determining (201) a starting pressure present in the fuel cell stack (101) of the fuel cell system (100) during a starting process by means of a pressure sensor (111),
actuating (203) the outlet system (107) of the fuel cell system (100) such that enough anode gas is discharged from the anode subsystem (105) that a non-hydrogen-containing gas mixture present in the anode subsystem (105) at the starting pressure is enriched with hydrogen by the supply system (109) to a specified minimum hydrogen concentration.

9. The method (200) according to claim 8,
wherein
a duration for which the outlet system (107) is actuated is calculated based on the starting pressure.

10. The method (200) according to claim 8,
wherein
when a predetermined maximum pressure is reached in the fuel cell stack (101), a duration for which the outlet system (107) of the fuel cell system (100) is actuated is determined based on a predetermined characteristic map, wherein the characteristic map assigns an activation duration for activating the outlet system (107) to a starting pressure in the fuel cell stack (101) and a reference pressure.
